(19) United States
(12) Patent Application Publication
(10) Pub. No.: US 2007/0011611 A1
(43) Pub. Date: Jan. 11, 2007

(54) Digital TV and software download method therefor

(75) Inventor: Kyung-Hwan Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/475,883

(22) Filed: Jun. 28, 2006

(30) Foreign Application Priority Data
Jul. 11, 2005 (KR) 2005-0062090

(51) Int. Cl. G06F 3/00

(52) U.S. Cl. 715/700

(57) ABSTRACT

A software download method for digital TV is provided. The method comprises generating a GUI for inputting download option information, storing the download option information input through the option-selection GUI, determining whether software corresponding to the stored download option information exists in a broadcasting signal based on update information in a received broadcasting signal, and downloading a new version software if the software corresponding to the download option information exists. A digital TV that is capable of providing various kinds of system software in accordance with a user's selection and a software download method therefore are provided.

### PRIORITY

This application claims the benefit under 35 U.S.C. § 119(a) of Korean Patent Application No. 2005-0062090, filed Jul. 11, 2005, in the Korean Intellectual Property Office, the entire disclosure of which is hereby incorporated by reference.

### BACKGROUND OF INVENTION

1. Field of Invention

The present invention relates to a digital TV and a software download method therefor. More particularly, the present invention relates to a digital TV that is capable of providing various kinds of system software in accordance with a user's option selection and a software download method therefor.

2. Description of the Related Art

In recent years, as digital broadcasting has progressed, the prevalence of digital TV has increased. In digital broadcasting, contrary to analog broadcasting, video and audio signals are converted into digital signals and then compressed. Thereafter, the compressed digital signals are packeted and transmitted to a transport stream. Such a digital TV stores various system software related to operations of the digital TV. The system software includes Electronic Program Guide (EPG) information containing channel information in memory, such as flash memory or an EEPROM within digital TV sets. With development of digital broadcasting, the aforementioned system software related to operations of the digital TV should also be updated.

Accordingly, a process of updating system software in conventional digital TV will now be described. In conventional digital TV, product information and version information relative to a particular TV model is stored by the system software. Hence, when updating system software, the digital TV searches a System Software Update Specification (SSUS) table among additional information in the transport stream of a broadcasting signal according to a predetermined channel. The SSUS information records information on manufacturing companies, manufacturing model groups, version information, and the like, with respect to various kinds of software transmitted together in the transport stream of the broadcasting signal. Therefore, if it is determined that a new version of updatable software of a particular model group exists in the broadcasting signal while searching the SSUS information, the digital TV downloads the new version of the updatable software and then updates the currently stored software.

In the foregoing software download method of a conventional digital TV, new software versions can be downloaded based only on the version information of the model group of the digital TV and the currently stored system software. That is, only one kind of system software can be updated for use in a single digital TV. Accordingly, conventional digital TV cannot actively address the situation where the physical environment of a digital TV has changed, that is, for example, when a digital TV used in Korea is then used in Germany, or that is required to update using a different kind of system software suitable for a user's personal taste.

### SUMMARY OF THE INVENTION

Accordingly, it is an aspect of exemplary embodiments of the present invention to provide a digital TV that is capable of providing various kinds of system software in accordance with a user's selection and software download method therefor.

The foregoing and other aspects and features of exemplary embodiments of the present invention can be achieved by providing a software download method for a digital TV, the method comprising generating an option selection graphical use interface (GUI) for inputting download option information relative to software selection, storing the download option information input through the option-selection GUI, determining whether software corresponding to the stored download option information exists in a broadcasting signal based on update information in a received broadcasting signal, and downloading a new software version if the software corresponding to the download option information exists.

According to an aspect of exemplary embodiments of the present invention, the step of determining whether software exists in the broadcasting signal further comprises extracting System Software Update Specification (SSUS) information in the broadcasting signal, and determining whether a new software version corresponding to the stored download option information exists based on the SSUS information.

According to an aspect of exemplary embodiments of the present invention, the download option information contains at least one of area information for selecting a broadcasting reception area, age information for selecting a broadcast viewing generation, gender distinction information for selecting a broadcast viewing gender distinction, and data broadcasting information for selecting data broadcasting.

According to an aspect of exemplary embodiments of the present invention, the method further comprises downloading a new software version corresponding to previously stored basic information if the download option information has not previously been stored.

According to an aspect of exemplary embodiments of the present invention, generating the option-selection GUI comprises selecting a function directed to changing the download option information, searching the software related to the option-selection GUI corresponding to previously stored basic information based on the SSUS information in the received broadcasting signal, downloading and storing the software related to the option-selection GUI, and generating the option-selection GUI using the stored software.

The foregoing and other aspects and features of exemplary embodiments of the present invention can be also achieved by providing a digital TV having a signal reception unit for receiving a broadcasting signal and a decoding unit for decoding data of the received broadcasting signal, the digital TV comprising a GUI generation unit for generating an option-selection GUI, a storage unit for storing download option information input through the option-selection GUI, and a control unit for controlling the GUI generation unit to generate the option-selection GUI for inputting the download option information related to a software download, and storing the download option information input through the option-selection GUI in the storage unit when a function directed to changing the download option information is selected.

According to an aspect of exemplary embodiments of the present invention, the control unit extracts update information in the received broadcasting signal from the decoding unit and determines whether a new software version corresponding to the stored download option information exists in the broadcasting signal, then downloads the software if the new software version exists.

According to an aspect of exemplary embodiments of the present invention, the control unit extracts SSUS information in the broadcasting signal from the decoding unit and determines whether the new software version exists based on the SSUS information.

According to an aspect of exemplary embodiments of the present invention, the download option information contains at least one of area information for selecting a broadcasting reception area, age information for selecting a broadcast viewing generation, gender distinction information for selecting a broadcast viewing gender distinction and data broadcasting information for selecting data broadcasting.

According to an aspect of exemplary embodiments of the present invention, the storage unit stores basic information related to the software downloaded, and the control unit downloads the new software version corresponding to previously stored basic information if the download option information has not previously been stored.

According to an aspect of exemplary embodiments of the present invention, the control unit extracts the SSUS information in the received broadcasting signal from the decoding unit and searches the software related to the option-selection GUI corresponding to the basic information, then controls the GUI generation unit to generate the option-selection GUI using the searched software when a function directed to changing the download option information is selected.

### BRIEF DESCRIPTION OF THE DRAWINGS

The above and other aspects, exemplary features and advantages of the prevent invention will become more apparent by describing certain exemplary embodiments of the present invention with reference to the accompanying drawings, in which:

FIG. 1 is a control block diagram of a digital TV according to an exemplary embodiment of the present invention;

FIG. 2 is a control flowchart illustrating a software download method for a digital TV according to a first exemplary embodiment of the present invention;

FIG. 3 is a control flowchart illustrating a software download method for a digital TV according to a second exemplary embodiment of the present invention; and

FIG. 4 is view showing an example of a GUI and download setting information in a digital TV according to an exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

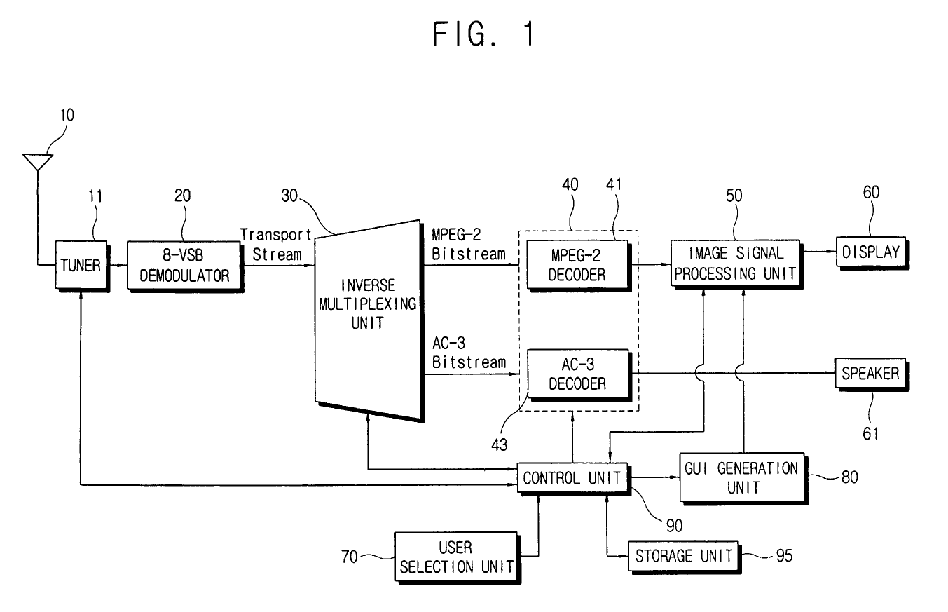

FIG. 1 is a control block diagram of a digital TV according to an exemplary embodiment of the present invention. As shown therein, the digital TV according to an exemplary embodiment of the present invention comprises an antenna 10, a tuner 11, an 8-VSB demodulator 20, an inverse multiplexing unit 30, a decoding unit 40, an image signal processing unit 50, a display 60, a speaker 61, a user selection unit 70, a GUI generation unit 80, a control unit 90, and a storage unit 95.

Digital broadcasting signals are transmitted in the form of a transport stream packeted by time division multiplexing video signals, audio signals and data information.

The tuner 11 tunes broadcasting signals received through the antenna 10 to the broadcasting signals having a frequency band corresponding to the tuning control signal of the control unit 90.

The broadcasting signals of a specific channel tuned in this manner are output in the form of a transport stream through a vestigial sideband (VSB) demodulating process, an error correcting process, and the like, by the 8-VSB demodulator 20. The broadcasting signals are then separated into video signals, audio signals and various kinds of additional data defined as program and system information protocol (PSIP) information by the inverse multiplexing unit 30, and output in the form of a bit stream.

The video data separated through the inverse multiplexing unit 30 are decoded by an MPEG-2 decoder 41 and displayed on the display 60 through a process of the image signal processing unit 50. The display 60 can be applied to various types of display modules such as Digital Light Processing (DLP), Liquid Crystal Display (LCD) or Plasma Display Panel (PDP). The image signal processing unit 50 comprises a scaler for converting video signals to correspond to a vertical frequency, resolution, a screen ratio, and the like, which meet a output standard of the display 60.

The audio signals are decoded by the AC-3 decoder 43 and output to the speaker 61. Meanwhile, various kinds of additional data contained in the PSIP information are stored in memory (not shown) by each data table by the control unit 90. Further, data required to display the additional data on a screen are processed through the image signal processing unit 50 in accordance with the control of the control unit 90 and mixed with currently tuned video signals to be processed, then output to the display 60. Furthermore, as necessary, the additional data may be generated as image signals by the GUI generation unit 80 in accordance with the control of the control unit 90, and then processed through the image signal processing unit 50.

The PSIP information comprises System Time Table (SST), Master Guide Table (MGT), Virtual Channel Table (VCT), Rating Region Table (RRT), Event Information Table (EIT) and Extended Text table (ETT) information. In addition, System Software Update Specification (SSUS) information can be contained in the PSIP information.

The user selection unit 70 can be used to input selection and release of a software update function, and selection and release of a download option information changing function, and download option information. The user selection unit 70 comprises menu keys provided in a wireless remote controller and a key signal generation unit for generating key signals corresponding to key operations. The user selection unit 70 may also be provided with a mouse, a keyboard, or the like, or positioned on the body panel of a digital TV.

The GUI generation unit 80 generates a download option selection menu in which download option information can be input in accordance with control of the control unit 90. The download option selection menu is generated by the GUI generation unit 80 to input download option information, and the GUI generation unit 80 is preferably provided with an On Screen Display (OSD) generation unit for generating an OSD menu.

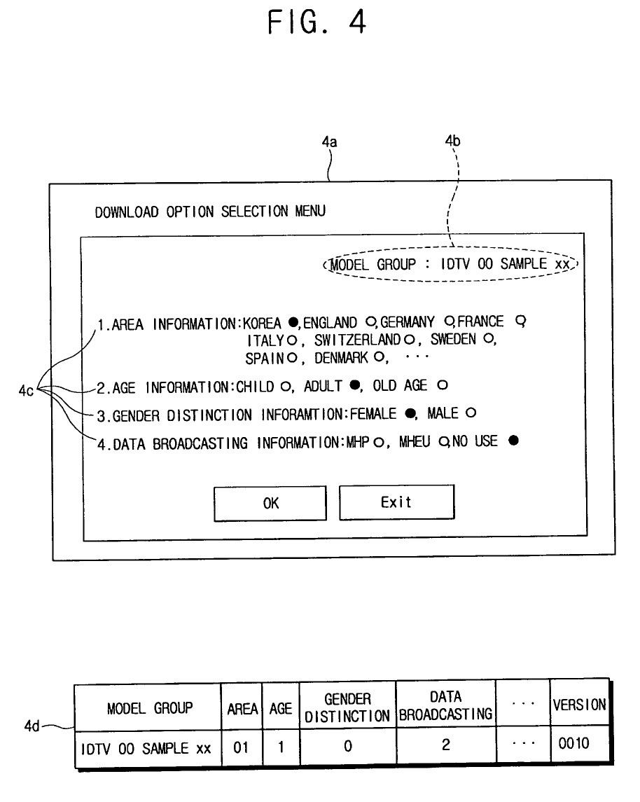

As shown in FIG. 4, on the download option selection menu 4a generated by the GUI generation unit 80, are displayed basic information comprising product model group information 4b being downloaded, and area information 1 for selecting a broadcasting reception area, age information 2 for selecting a broadcast viewing age, gender distinction information 3 for selecting a broadcast viewing gender distinction, and data broadcasting information 4 for selecting data broadcasting, which comprise the option information 4c available for selection. The product model group information 4b is fixed information and cannot be changed through the download option selection menu 4a.

For example, as shown in FIG. 4, through the download option selection menu 4a generated by the GUI generation unit 80 by operating the user selection unit 70, if “Korea” is selected as the area information 1, “adult” as the age information 2, “female” as the gender distinction information 3, and “no use” as the data broadcasting information 4 are selected, and then “OK” is selected, the GUI generation unit 80 does not generate the download option selection menu 4a in accordance with control of the control unit 90.

The control unit 90 stores the area information 1, the age information 2, the gender distinction information 3, the data broadcasting information 4, which comprise the download option information 4c input through the download option selection menu 4a, and the model group information 4b being fixed download basic information in the storage unit 95 in the form of download setting information as shown in 4d of FIG. 4. Accordingly, the storage unit 95 stores the download option information 4c containing the area information 1, the age information 2, the gender distinction information 3, and the data broadcasting information, the product model group information 4b, and the download setting information 4d containing a version number of the currently stored system software (shown as 0010, by way of example).

Although area, age, gender distinction and data broadcasting information are displayed as download option information in the description, this is only one exemplary embodiment of the present invention. That is, more detailed area information (for example, Seoul, Pusan, etc.), more detailed age information (for example, generation), job information, and the like, as well as the aforementioned four information elements can variously be set as the download option information. The download option selection menu 4a generated in this manner is mixed with a video signal currently processed through the image signal processing unit 50 and then displayed on the display 60.

The control unit 90 receives a key signal from the user selection unit 70 and then controls the corresponding function to be executed. The control unit 90 is embodied by a controller such as a microcomputer.

If a function relating to changing the download option information is selected through the user selection unit 70, the control unit 90 controls the GUI generation unit 80 such that the download option selection menu 4a shown in FIG. 4 is displayed on the display 60. As describe above, the control unit 90 stores the download option information 4c changed/input through the download option selection menu 4a, the model group information 4b, and the version information in the storage unit 95 in the form of the download setting information 4d of FIG. 4.

If a function of updating software is selected through the user selection unit 70, or a predetermined event (such as, for example, implementation of a compulsory update in accordance with additional information of an input broadcasting signal) is input, the control unit 90 extracts SSUS information among various kinds of additional data contained in PSIP information separated through the inverse multiplexing unit 30. The control unit 90, searching the extracted SSUS information, then determines whether there exists a new version of updatable software corresponding to the model group information 4b and the download option information 4c based on the download setting information 4d stored in the storage unit 95.

If a new software version corresponding to the stored information (for example, model group information, option information, version information) stored in the storage unit 95 exists in the SSUS information, the control unit 90 determines that the new software version exists in the broadcasting signal containing the SSUS information and downloads the software received through the broadcasting signal. Therefore, the control unit 90 is capable of updating currently stored software as the downloaded software.

If the download option information 4c is not stored in the download setting information 4d stored in the storage unit 95, in one exemplary implementation the control unit 90, searching the SSUS information, determines whether there exists a new software version in consideration of only the model group information 4b being download basic information and the version information.

Therefore, a digital TV according to exemplary embodiments of the present invention can improve upon the monotony produced by a conventional digital TV, in which it is possible to update and use only one kind of system software. That is, if a user changes/inputs the download option information 4c through the download option selection menu 4a when it is required to update as a different kind of system software suitable for a user's personal taste, the digital TV of exemplary embodiments of the present invention can download system software corresponding to the input download option information 4c. Thus, the digital TV of exemplary embodiments of the present invention can actively download and update various kinds of system software in accordance with the download option information 4c.

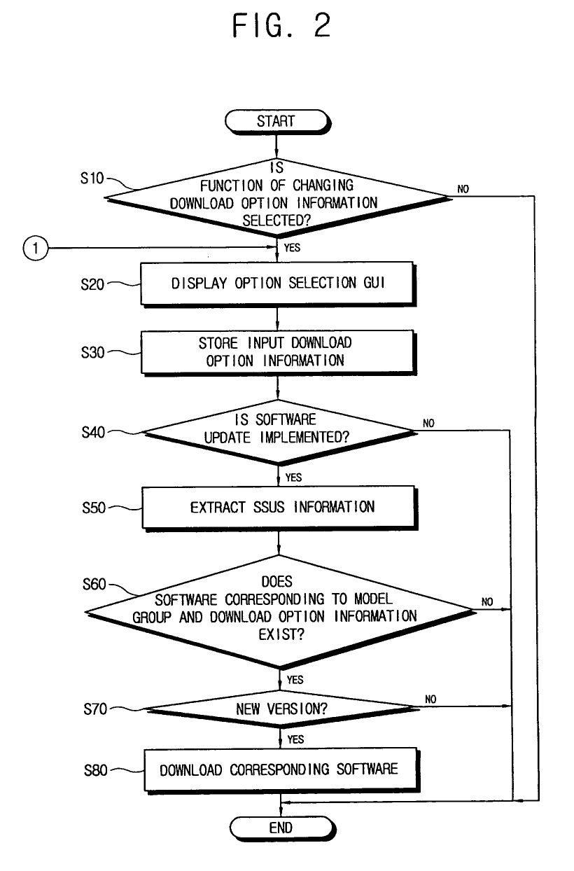

A first exemplary embodiment of a software download method for a digital TV according to exemplary embodiments of the present invention having such a configuration will be described below with reference to FIG. 2.

First, the control unit 90 determines whether a function directed to changing the download option information is selected through the user selection unit 70 at operation S10. If the function of changing download option information has been selected, the control unit 90 controls the GUI generation unit 80 to display the download option selection menu 4a of FIG. 4 on display 60 at operation S20. Thus, the control unit 90, as described above, stores download option information 4c (for example, area information 1, age information 2, gender distinction information 3, and data broadcasting information 4) changed/input through the download option selection menu 4a in the storage unit 95 in accordance with operations of the user selection unit 70 at operation S30. The download basic information (for example, model group information 4b) comprises fixed information, version information of currently stored system software, and the download option information 4c input through the download option selection menu 4a are stored in the storage unit 95.

Then, the control unit 90 determines whether a function directed to updating software is selected through the user selection unit 70, or a function of updating software, such as an input of a predetermined event (such as, for example, implementation of a compulsory update in accordance with additional information of an input broadcasting signal) or the like, is executed at operation S40. If the software update function is executed, the control unit 90 extracts SSUS information among various kinds of additional information contained in PSIP information separated through the inverse multiplexing unit 30 at operation S50. Searching the extracted SSUS information at operation S60, the control unit 90 then determines whether there exists updatable software corresponding to the model group information 4b and the download option information 4c based on information stored in the storage unit 95 (for example, model group information, option information, version information). Further, if there exists updatable software, the control unit 90 determines whether the corresponding software is a newer version than the current version at operation S70. If a new software version corresponding to the information stored in the storage unit 95 through the operations of S60 and S70 exists in the SSUS information, the control unit 90 determines that a new software version exists in the broadcasting signal containing the SSUS information and downloads the software received through the broadcasting signal at operation S80. Therefore, the control unit 90 is capable of updating currently stored software.

Accordingly, the software download method for a digital TV according to exemplary embodiments of the present invention can improve upon the monotony produced by a conventional digital TV, in which it is possible to update and use only one kind of system software. That is, if a user changes/inputs the download option information 4c through the download option selection menu 4a when it is required to update as a different kind of system software suitable for a user's personal taste, the software download method for a digital TV of exemplary embodiments of the present invention can download system software corresponding to the input download option information 4c. Hence, the digital TV of exemplary embodiments of the present invention can actively download and update various kinds of system software in accordance with the download option information 4c.

Because the GUI generation unit 80 has already stored software related to the GUI for displaying the download option selection menu 4a of FIG. 4, the first exemplary embodiment shows a configuration wherein the GUI generation unit 80 generates the download option selection menu 4a using the previously stored software related to the GUI in accordance with control of the control unit 90.

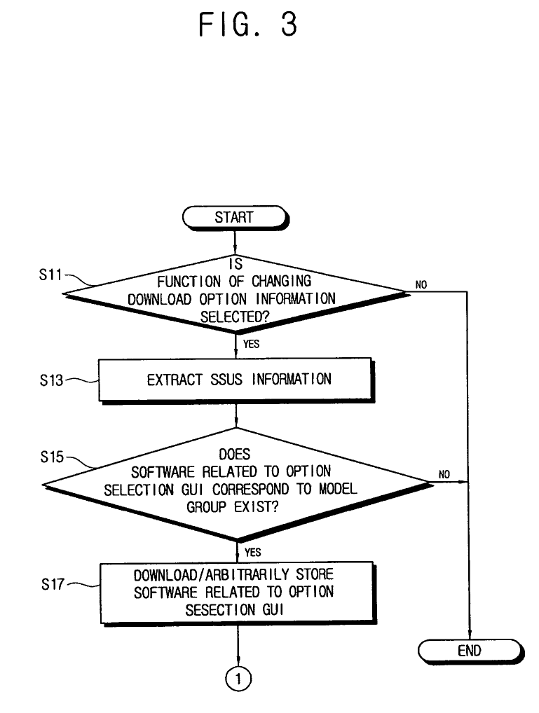

A software download method for a digital TV wherein software related to a GUI for displaying a download option selection menu 4a has not previously been stored, according to a second exemplary embodiment of the present invention, will be described below with reference to FIG. 3.

First, the control unit 90 determines whether a function directed to changing the download option information is selected through the user selection unit 70 at operation S11. If the function of changing the download option information has been selected, the control unit 90 extracts SSUS information contained in PSIP information separated through the inverse multiplexing unit 30 among received broadcasting signals at operation S13. The control unit 90 then determines whether software exists that is related to the GUI corresponding to the model group information 4b being downloaded and searches the extracted SSUS information at operation S15. The model group information 4b is fixed and is not changed contrary to download option information 4c input through download option selection information 4a, but stored at the time the digital TV was manufactured.

If the software related to the GUI corresponds to the model group information 4a exists in the SSUS information, the control unit 90 determines that the software related to the corresponding option-selection GUI exists in the broadcasting signal containing the SSUS information and downloads the software related to the corresponding option-selection GUI received through the broadcasting signal, then temporarily stores it at operation S17. Thereafter, using the arbitrarily stored software related to the option-selection GUI, the control unit 90 controls the GUI generation unit 80 such that the download option selection menu 4a is displayed on the display 60 at operation S20 in FIG. 2. Since, the rest processes hereafter is the same as that of the software download method for a digital TV according to the first embodiment described with reference to FIG. 2, a detailed description will be omitted.

Accordingly, in the software download method for a digital TV according to the second exemplary embodiment of the present invention, if a function directed to changing the download option information is selected, corresponding software related to option selection vis-à-vis the GUI is received through a broadcasting signal is searched/downloaded and then stored, such that a download option selection menu 4a can be provided.

The software download method for a digital TV according to the second exemplary embodiment of the present invention can improve upon the monotony produced by a conventional digital TV, which is possible to update and use only one kind of system software. That is, the software download method for a digital TV according to the second exemplary embodiment of the present invention is possible to actively download and update various kinds of system software in accordance with the download option information 4c changeable by a user.

As described above, a digital TV and a software download method therefor, according to exemplary embodiments of the present invention, are possible to actively download and update various kinds of system software in accordance with the download option information 4c changeable by a user. Accordingly, a digital TV and a software download method therefor, according to exemplary embodiments of the present invention, can provide various functions using system software that is suitable for a user's personal taste.

In light of the foregoing, according to exemplary implementations of the present invention, there can be provided a digital TV that is capable of providing various kinds of system software in accordance with a user's selection and software download method therefor.

While the present invention has been particularly shown and described with reference to certain exemplary embodiments thereof, it will be understood by those of ordinary skill in the art that various changes in form and detail may be made therein without departing from the spirit and scope of the present invention as defined by the appended claims and equivalents thereof.

What is claimed is:

1. A software download method for a digital TV, the method comprising:
generating an option-selection GUI for inputting download option information;
storing the download option information input through the option-selection GUI;
determining whether a broadcasting signal comprises software corresponding to the stored download option information based on update information in a received broadcasting signal; and
downloading a new software version if the new software version corresponding to the download option information exists.

2. The method according to claim 1, wherein the determining comprises:
extracting System Software Update Specification (SSUS) information in the broadcasting signal; and
determining whether a new software version corresponding to the stored download option information exists based on the SSUS information.

3. The method according to claim 2, wherein the download option information comprises at least one of area information for selecting a broadcasting reception area, age information for selecting a broadcast viewing generation, gender distinction information for selecting a broadcast viewing gender distinction, and data broadcasting information for selecting data broadcasting.

4. The method according to claim 3, further comprising downloading the new software version corresponding to previously stored basic information if the download option information has not previously been stored.

5. The method according to claim 1, wherein the generating of the option-selection GUI, comprises:
selecting a function directed to changing the download option information;
searching the software related to the option-selection GUI corresponding to previously stored basic information based on the SSUS information in the received broadcasting signal;
downloading and storing the software related to the option-selection GUI; and
generating the option-selection GUI using the stored software.

6. The method according to claim 4, wherein the generating of the option-selection GUI, comprises:
selecting a function directed to changing the download option information;
searching the software related to the option-selection GUI corresponding to previously stored basic information based on the SSUS information in the received broadcasting signal;
downloading and storing the software related to the option-selection GUI; and
generating the option-selection GUI using the stored software.

7. A digital TV comprising:
a signal reception unit for receiving a broadcasting signal;
a decoding unit for decoding data of the received broadcasting signal;
a GUI generation unit for generating an option-selection GUI;
a storage unit for storing download option information input through the option-selection GUI; and
a control unit for controlling the GUI generation unit to generate the option-selection GUI for inputting the download option information related to software download, and storing the download option information input through the option-selection GUI in the storage unit when a function directed to changing the download option information is selected.

8. The digital TV according to claim 7, wherein the control unit is configured to extract update information in the received broadcasting signal from the decoding unit, determine whether the broadcasting signal comprises a new software version corresponding to the stored download option information and download the software if the broadcasting signal comprises the new software version exists.

9. The digital TV according to claim 8, wherein the control unit is further configured to extract System Software Update Specification (SSUS) information in the broadcasting signal from the decoding unit and determine whether the new software version exists based on the SSUS information.

10. The digital TV according to claim 9, wherein the download option information comprises at least one of area information for selecting a broadcasting reception area, age information for selecting a broadcast viewing generation, gender distinction information for selecting a broadcast viewing gender distinction, and data broadcasting information for selecting data broadcasting.

11. The digital TV according to claim 10, wherein the storage unit stores basic information related to the software downloaded, and the control unit is configured to download the new software version corresponding to previously stored basic information if the download option information has not previously been stored.

12. The digital TV according to claim 8, wherein the control unit is configured to extract the SSUS information in the received broadcasting signal from the decoding unit, search the software related to the option-selection GUI corresponding to the basic information, and control the GUI generation unit to generate the option-selection GUI using the searched software when a function directed to changing the download option information is selected.

13. The digital TV according to claim 11, wherein the control unit is configured to extract the SSUS information in the received broadcasting signal from the decoding unit, search the software related to the option-selection GUI corresponding to the basic information, and control the GUI generation unit to generate the option-selection GUI using the searched software when a function directed to changing the download option information is selected.
